(19) United States
(12) Patent Application Publication
(10) Pub. No.: US 2013/0173886 A1
(43) Pub. Date: Jul. 4, 2013

(54) Processor with Hazard Tracking Employing Register Range Compares

(71) Applicants: Kenneth Alan Dockser, Cary, NC (US); Yusuf Cagatay Tekmen, Raleigh, NC (US)

(72) Inventors: Kenneth Alan Dockser, Cary, NC (US); Yusuf Cagatay Tekmen, Raleigh, NC (US)

(73) Assignee: QUALCOMM INCORPORATED, San Diego, CA (US)

(21) Appl. No.: 13/343,010

(22) Filed: Jan. 4, 2012

(51) Int. Cl. G06F 9/30; G06F 9/38

(52) U.S. Cl. 712/215; 712/216; 712/217; 712/E09.023; 712/E09.02; 712/E09.049

(57) ABSTRACT

Systems and methods for tracking data hazards in a processor. The processor comprises a pipelined architecture configured to execute a first instruction and a second instruction, wherein the second instruction is older than the first instruction. At least one of the first and second instructions comprises at least one operand expressed as a range of registers. Hazard detection logic is configured to compare the first instruction and the second instruction to determine if there is a data hazard, prior to expanding the second instruction.

### FIELD OF DISCLOSURE

Disclosed embodiments are directed to data hazard detection. More particularly, exemplary embodiments are directed to data hazard tracking in processors employing instructions with register ranges, without expanding the instructions.

### BACKGROUND

Modern processing systems may support execution of instructions in a pipelined fashion as well as out of program order. In the case of pipelined execution, an operation may start execution before the prior operation has completed. When executing out of program order, operations may start execution of an instruction before starting the execution of one or more programmatically prior instructions. These techniques are employed to minimize wastage of instruction cycles, and exploit parallelism in instruction sequences. However, pipelining and out-of-order execution may lead to data hazards which are situations where incorrect operation would result if a programmatically younger instruction were to read or write operands (“operands” may be source or destination operands specified by an instruction) before an older instruction has read or written them.

Data hazards arise from the order imposed by the program being executed and include Read-After-Write (RAW), Write-After-Read (WAR), Write-After-Write (WAW) hazards. While data hazards often arise when operands have the same data size, they may also arise in cases where operands overlap in the registers used. For example, if an older instruction writes a quadword (the size of a quadword is four times the size of a word) and a younger instruction requires a word of that quadword, a hazard may arise. It will be erroneous for the younger instruction to execute before it can procure the required word produced by the older instruction.

In some architectures, operands of instructions may be expressed as a range of register addresses. For example, storage instructions for loading multiple registers, or Single Instruction Multiple Data (SIMD) instructions may comprise operands spanning several registers and expressed in terms of a range of registers. Likewise, different data types may span a different number of registers. For example, a data word may comprise one 32-bit register while a doubleword may comprise a range of two contiguous 32-bit registers and a quadword may comprise a range of four contiguous 32-bit registers. In order to detect and resolve data hazards for such instructions, it is necessary to determine if any of the registers covered by the range may give rise to a dependency. Conventional techniques for determining whether any of the component registers in a range of registers of an instruction operand may cause a data hazard include expanding the range of registers into component registers and checking for hazards on each of the component registers.

As can be seen, such conventional techniques may require a large number of compare operations to be performed. The number of compare operations increases with the number of registers expressed in the instruction operands, and also with the number of instructions which may be in flight in the pipeline. Further, conventional techniques require expansion of the range of registers expressed in instruction operands into component registers before comparison operations may be performed for checking data hazards. This expansion places an increased demand on storage space in an instruction queue holding instructions prior to dispatch, thus offsetting the benefits and efficiency of a condensed expression of the operands as a range of registers.

Accordingly there is a need in the art for efficient techniques for detecting data hazards for instructions comprising operands expressed in terms of a range of registers, without requiring expansion.

### SUMMARY

Exemplary embodiments of the invention are directed to systems and method for tracking data hazards.

For example, an exemplary embodiment is directed to method for tracking data hazards in a processor comprising: tracking a first instruction; and comparing the first instruction to a second instruction to determine if there is a data hazard, prior to expanding the second instruction.

Another exemplary embodiment is directed to a processor comprising: a pipelined architecture configured to execute a first and a second instruction; and hit detection logic for comparing the first instruction to the second instruction to determine if there is a data hazard, prior to expanding the second instruction.

Another exemplary embodiment is directed to a processing system for tracking data hazards in a processor comprising: means for tracking a first instruction; and means for comparing the first instruction to a second instruction to determine if there is a data hazard, prior to expanding the second instruction.

Yet another exemplary embodiment is directed to a non-transitory computer-readable storage medium comprising code, which, when executed by a processor, causes the processor to perform operations for tracking data hazards in the processor, the non-transitory computer-readable storage medium comprising: code for tracking a first instruction; and code for comparing the first instruction to a second instruction to determine if there is a data hazard, prior to expanding the second instruction.

### BRIEF DESCRIPTION OF THE DRAWINGS

The accompanying drawings are presented to aid in the description of embodiments of the invention and are provided solely for illustration of the embodiments and not limitation thereof.

FIG. 1 illustrates a processing system configured according to exemplary embodiments for data hazard detection.

FIG. 2 illustrates a schematic implementation of comparison logic for data hazard detection according to exemplary embodiments.

FIG. 3 illustrates a flow-chart detailing a method for data hazard detection according to exemplary embodiments.

FIG. 4 illustrates an exemplary wireless communication system 400 in which an embodiment of the disclosure may be advantageously employed.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a” “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

Exemplary embodiments include techniques for detecting data hazards on instructions comprising operands expressed as a range of registers, without requiring prior expansion of the range of registers into component registers. Accordingly, embodiments may require less compare operations than conventional techniques described above, which require expansion to component registers before comparison. Moreover, exemplary embodiments may conserve storage space in instruction queues by operating on an un-expanded range of registers.

As discussed herein, the term “expanded instruction” may refer to an instruction comprising operands expressed as a range of registers expanded into an equivalent instruction with operands expressed as expanded component registers or alternately, as expanded into smaller ranges. Correspondingly, “non-expanded instructions” may refer to the original instruction which has not been expanded. The size/bit-width of component registers may be based on the size/bit-width of data path elements. Register ranges in instructions may be expressed in terms of a start address and an end address, including all the component registers within the range. Register ranges may also be limited to comprise only a subset of component registers within the range, such as even-numbered registers, odd-numbered registers, real/complex registers etc. In detecting data hazards, embodiments may support several forms of comparisons, such as comparisons of non-expanded instructions with non-expanded instructions, expanded instructions with non-expanded instructions, and expanded instructions with expanded instructions. Once hazards have been detected according to exemplary embodiments, they may be resolved according to well-known techniques, such as register renaming or selective delaying of younger instructions to enforce in-order execution.

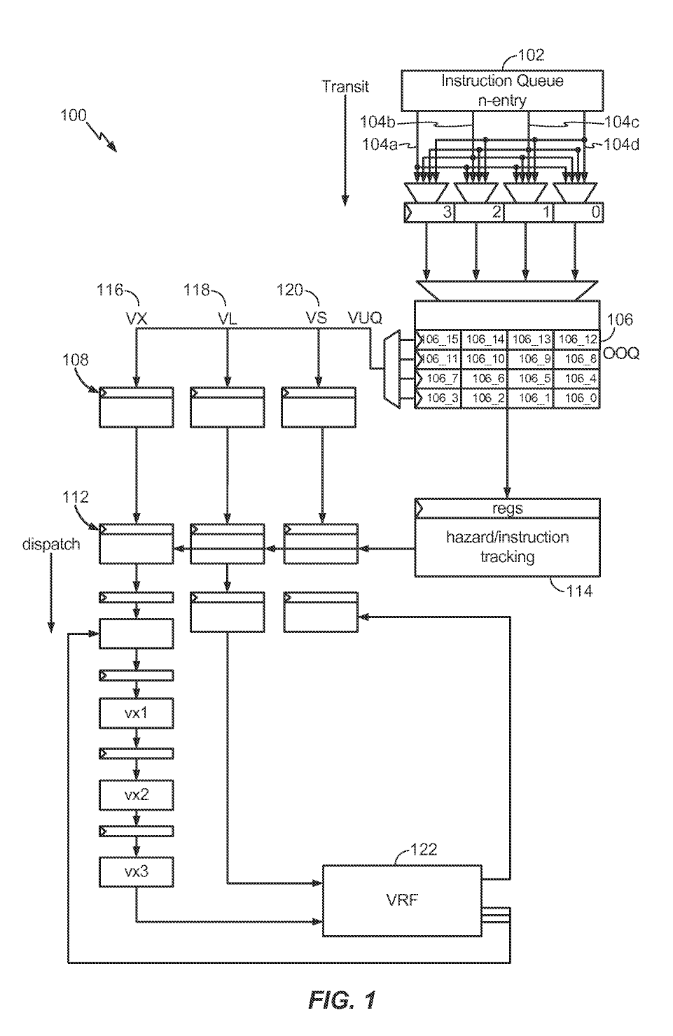

With reference now to FIG. 1, processing system 100, configured to support pipelined and out-of-order execution, is illustrated. Processing system 100 may be a main processor or a co-processor. Instructions may be fetched and delivered to instruction queue 102 before dispatch. Instruction queue 102 may separate the received instructions into four parallel instruction streams 104a, 104b, 104c, and 104d, and deliver the received instructions to out-of-order queue (OOQ) 106. OOQ 106 may be configured as a holding area for instructions before they are dispatched to parallel execution pipelines VX 116, VL 118, and VS 120. OOQ 106 may comprise 16 entries, which have been designated by the reference numbers 106_0 . . . 106_15 as shown. Entries 106_0-106_15 may hold non-expanded instructions which may comprise operands expressed as a range of registers. The range of registers may be addressed based on the address space of vector register file VRF 122. Entry 106_0 may correspond to the oldest instruction, and entry 106_15 may correspond to the youngest instruction within OOQ 106.

While each entry in OOQ 106 may have room for instructions comprising three operand fields, each of pipelines VX 116, VL 118, and VS 120 may support specific instruction formats. For example, pipeline VX 116 may support instructions with a total of three operand fields—two source operand fields and one combination source and destination operand field. The three operand fields may be expressed as a range of registers. Similarly, pipelines VL 118 and VS 120 may each support instructions with two operand combination sourer and destination operand fields, once again where each operand field may be expressed as a range of registers. Accordingly, a total of seven operand fields may comprise register ranges among the instructions executed by pipelines VX 116, VL 118, and VS 120 in each pipeline stage.

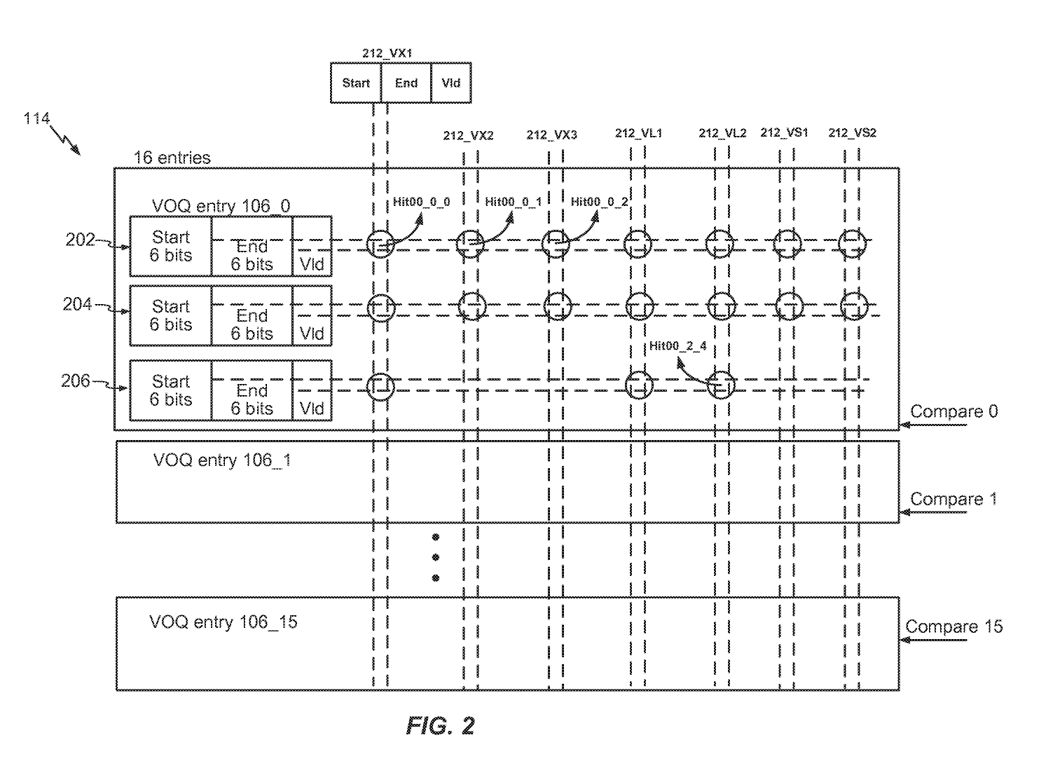

Two pipeline stages, 108 and 112 are illustrated for each pipeline VX 116, VL 118, and VS 120. These pipeline stages may include one or more of expand, decode, and resolve stages. In one example, data hazards may be detected by hazard detection logic 114 when instructions reach pipeline stage 112. It will be recalled that because instructions may be released out-of-order from OOQ 106 to pipelines VX 116, VL 118, and VS 120, some instructions still residing in OOQ 106 may be older than instructions which have reached pipeline stage 112. Thus, operands of instructions in pipeline stage 112 may be checked for hazard conditions against older instructions residing in OOQ 106. Operands of instructions in pipeline stage 112 in the various pipelines, VX 116, VL 118, and VS 120, may be in expanded or non-expanded format and thus may be expressed as individual registers, a set of component registers or a range that is a subset of a register range. Both expanded and non-expanded instructions in pipeline stage 112 may be checked for hazard conditions against instructions OOQ 106 using hazard detection logic 114. A detailed implementation of hazard detection logic 114 has been provided with reference to FIG. 2.

As previously described, each of entries 106_0-106_15 of OOQ 106 may comprise instructions comprising a maximum of three (3) operand fields, and the total number of operand fields of instructions in pipeline stage 112 of pipelines VX 116, VL 118, and VS 120 is seven (7). Accordingly, in detecting hazards, potential overlaps may exist between the 7 operand fields in pipeline stage 112 and each of the 3 operand fields of entries 106_0-106_15 in OOQ 106. Thus, hazard detection for each entry in OOQ 106 may involve 7×3=21 comparisons of operand fields expressed as registers. It will be recognized that these 21 comparisons includes comparisons of all source and destination operand fields of instructions in pipeline stage 112 with each of entries 106_0-106_15. Accordingly, the 21 comparisons will include detection of all Write-After-Read (WAR), Read-After-Write (RAW), Write-After-Write (WAW) and Read-After-Read (RAR) conditions.

However, it will also be recognized that RAR is not a true data hazard condition because reading a register does not modify its value. Thus, a younger instruction may read a register before an older instruction reads the same register, without creating a hazard. Therefore, by culling out the comparisons for RAR conditions, only 17 comparisons may be required for testing entries 106_0-106_15 for potential data hazards.

In each of the 17 comparisons, when an operand is expressed in the form of a range of registers, embodiments may be configured to implement the comparisons without expanding the range of registers into component registers. The size of each register in the range of registers may be based on a granularity of data access of a register file such as VRF 122. In order to detect a dependency between a first operand expressed as a first range of registers spanning between register addresses {first_start, first_end} and a second operand expressed as a second range of registers spanning between register addresses {second_start, second_end}, a dependency may be assumed to exist if there are any common registers (i.e. overlap) between the two ranges, {first_start, first_end} and {second_start, second_end}. Thus, if the first operand pertains to a first instruction, and the second operand pertains to a second instruction, then a data hazard between the first instruction and the second instruction is detected by comparing the first range and the second range and detecting at least one common register between the first range and the second range.

The first instruction may be a younger instruction in pipeline stage 112 of one of the pipelines VX 116, VL 118 or VS 120; and the second instruction may be an older instruction currently in flight or yet to be read from the OOQ 106 (instructions may remain in the OOQ 106 until they have written back to the register file). A dependency between the first operand and second operand may potentially result in a data hazard (i.e. one of the 17 comparisons, excluding comparisons for RAR conditions) if there is a common register between the first and second operands. In other words, a data hazard may be detected between the first range and the second range by implementing the logical function (second_start≦first_end) and (second_end≧first_start). If this logical function evaluates positively, i.e. to a “hit,” a data hazard may be determined to exist.

It will be recognized that a hit may indicate either a partial overlap comprising at least one common register or a complete overlap across the entire range of registers. Regardless of whether the overlap is partial or complete, a data hazard is assumed to exist, and must be resolved such that the younger of the two instructions does not access the register before the older instruction.

In one embodiment that has been illustrated in FIG. 2, the register addresses may be 6-bits wide. In order to implement the above logical equation in hardware detection logic 114 to detect a hit, 6-bit comparators may be used. Moreover, hazard detection logic 114 may be augmented with a mask for further refining the hit detection. For example, some instructions may comprise operands expressed as a range of registers, wherein the range is non-contiguous. In other words, the range may not span the entire address space between start and end address values, but may comprise only a subset, such as odd-numbered or even-numbered register addresses. Load/store instructions may address double words, such that depending on the start address value, the range may selectively include an odd-half or an even-half of quadwords between the start and end addresses. Masking functions may be accordingly implemented to limit comparisons to only the subset of registers that are actually included in the register range. In this manner, hit detection can be prevented from being overly inclusive and raising false flags of data hazards. In some embodiments, hit detection may also be gated with valid “vld” flags, such that only valid registers may trigger a hit.

Hit detection may be further gated to ensure that only older instructions are compared to the instruction being evaluated in pipeline stage 112. For example if a particular valid instruction in OOQ 106 is younger than the instruction in pipeline stage 112, hit detection may be gated from raising a hit flag for that particular instruction. Furthermore, the hit detection may be gated by the above-described mask, thereby saving the power consumed by the comparators. OOQ 106 may be written in-order but read out-of-order. When read out-of-order, the mask may be configured to enable compares to all older instructions from an arbitrary pointer (pointing to one of the entries 106_0-106_15) in the queue. The pointer may be used to track the age of the instruction being evaluated.

It will be noted that in cases where OOQ 106 is implemented as a circular queue, the instruction indices (i.e. 0-15) may wrap around. Initially, as new instructions are written into the queue, they will assume the next vacant position with the highest index (it will be recalled that entry 106_15 is the youngest instruction, while entry 106_0 is the oldest). Eventually all of the positions may be taken and the new instructions will need to be assigned vacated positions with lower indices. At this point, it may no longer be sufficient to label an instruction with a higher index as a younger instruction. Therefore the pointer will need to be reset accordingly.

With reference now to FIG. 2, a detailed implementation of hazard detection logic 114 will be provided. Hazard detection logic 114 may be configured to detect data hazards between instructions traversing pipelines VX 116, VL 118, and VS 120, and the 16 entries of OOQ 106 without expanding the respective operands. As previously stated, it is only necessary to perform hit detection against older instructions. Accordingly, it is never necessary to compare an instruction against itself while it still resides in the OOQ 106. Entry 106_0 of OOQ 106 is illustrated as comprising three operand fields, 202, 204, and 206, each expressed as a range of registers with 6-bit start and end address fields. A valid field is also included in operand fields 202, 204, and 206. While not explicitly illustrated, each of the remaining 15 entries, entries 106_1-106_15 of OOQ 106 are similarly comprised of three operands with 6-bit start and end address fields and a valid field.

Also shown is an operand field 212_VX1 with similar start and end address fields and a valid field. As described previously operand field 212_VX1 may be one of the three operand fields of an instruction in pipeline stage 112 of pipeline VX 116. Pipeline VX 116 may comprise instructions with three operand fields, whereas pipelines VL 118 and VS 120 may each comprise instructions with two such operand fields. Accordingly, the remaining operand fields of the VX 116, VL 118, and VS 120 pipeline have been schematically represented by 212_VX2, 212_VX3, 212_VL1, 212_VL2, 212_VS1, and 212_VS2.

Each of the circles represents comparison logic for triggering a hit signal. As noted previously, only 17 such hit detection operations may need to be performed for potential data hazards for each entry of OOQ106. The remaining of the 21 total dependencies correspond to RAR conditions which would not constitute a data hazard. Only a few representative circles have been labeled for the sake of clarity in hazard detection logic 114 of FIG. 2. For example, the circle labeled Hit00_0_0 represents comparisons for potential data hazards between operand field 202 of entry 106_0 of OOQ 106 and operand field 212_VX1. As described previously, 6-bit comparators augmented with appropriate masking logic may be utilized for implementing Hit00_0_0. Hit00_0_1 represents hit detection logic corresponding to operand fields 202, and 212_VX2; Hit00_0_2 represents hit detection logic corresponding to operand fields 202 and 212_VX3; and Hit00_2_4 represents hit detection logic corresponding to operand fields 206 and 212_VL2. It will be understood that a similar configuration may be repeated for data hazard detection for the remaining entries, entries 106_1-106_15 of OOQ 106. Accordingly, hazard detection logic 114 may be implemented to detect only the relevant data hazards between instructions traversing pipelines VX 116, VL 118, and VS 120, and the 16 entries of OOQ 106, without expanding the respective operands.

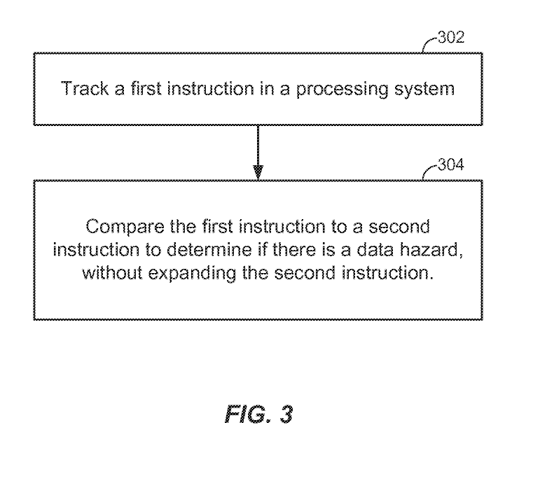

Accordingly, it will be appreciated that embodiments include various methods for performing the processes, functions and/or algorithms disclosed herein. For example, as illustrated in FIG. 3, an embodiment can include a method for tracking data hazards prior to dispatch in a processor (e.g. processing system 100), comprising: tracking a first instruction (e.g. instructions in pipeline stage 112 of pipelines VX 116, VL 118, and VS 120)—Block 302; and comparing (e.g. in hazard detection logic 114) the first instruction to a second instruction (e.g. older instructions in entries 106_0-106_15 of OOQ 106) to determine if there is a data hazard, without expanding the second instruction—Block 304.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

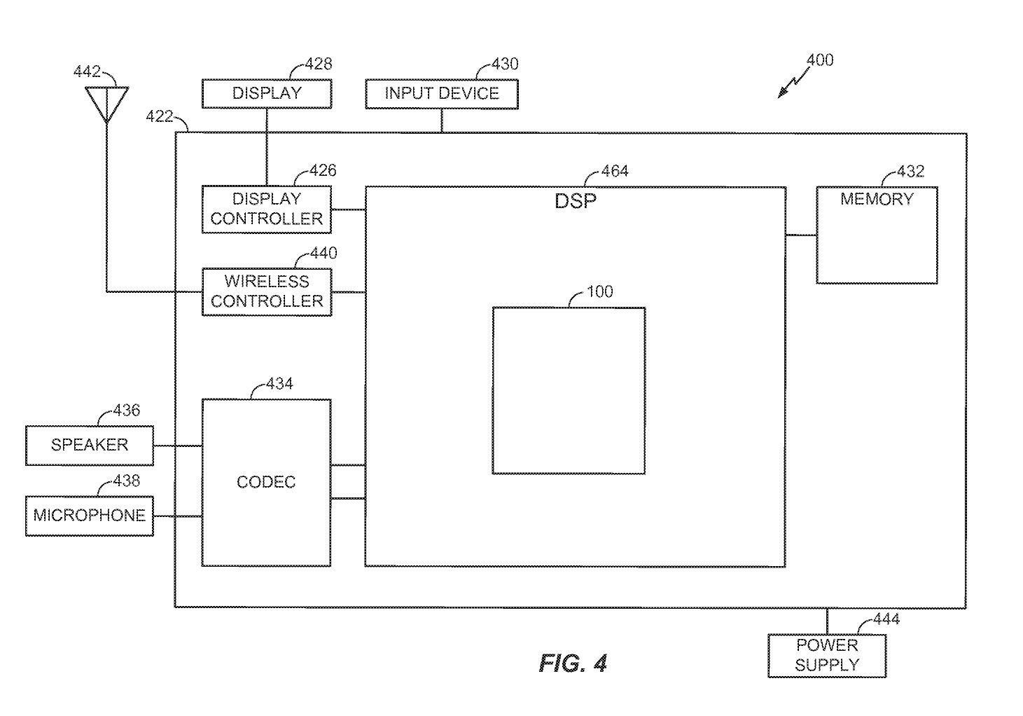

Referring to FIG. 4, a block diagram of a particular illustrative embodiment of a wireless device that includes a multi-core processor configured according to exemplary embodiments is depicted and generally designated 400. The device 400 includes a digital signal processor (DSP) 464 which may include processing system 100 of FIG. 1. FIG. 4 also shows display controller 426 that is coupled to DSP 464 and to display 428. Coder/decoder (CODEC) 434 (e.g., an audio and/or voice CODEC) can be coupled to DSP 464. Other components, such as wireless controller 440 (which may include a modem) are also illustrated. Speaker 436 and microphone 438 can be coupled to CODEC 434. FIG. 4 also indicates that wireless controller 440 can be coupled to wireless antenna 442. In a particular embodiment, DSP 464, display controller 426, memory 432, CODEC 434, and wireless controller 440 are included in a system-in-package or system-on-chip device 422.

In a particular embodiment, input device 430 and power supply 444 are coupled to the system-on-chip device 422. Moreover, in a particular embodiment, as illustrated in FIG. 4, display 428, input device 430, speaker 436, microphone 438, wireless antenna 442, and power supply 444 are external to the system-on-chip device 422. However, each of display 428, input device 430, speaker 436, microphone 438, wireless antenna 442, and power supply 444 can be coupled to a component of the system-on-chip device 422, such as an interface or a controller.

It should be noted that although FIG. 4 depicts a wireless communications device, DSP 464 and memory 432 may also be integrated into a set-top box, a music player, a video player, an entertainment unit, a navigation device, a personal digital assistant (PDA), a fixed location data unit, or a computer. A processor (e.g., DSP 464) may also be integrated into such a device.

Accordingly, an embodiment of the invention can include a computer readable media embodying a method for tracking data hazards prior to dispatch in a processor. Accordingly, the invention is not limited to illustrated examples and any means for performing the functionality described herein are included in embodiments of the invention.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method for tracking data hazards in a processor comprising:
tracking a first instruction; and
comparing the first instruction to a second instruction to determine if there is a data hazard, prior to expanding the second instruction.

2. The method of claim 1, wherein the second instruction is an older instruction.

3. The method of claim 1, wherein the data hazard is determined to exist if at least one operand of the first instruction and at least one operand of the second instruction have at least one overlapping register.

4. The method of claim 3, wherein the data hazard is one of a write-after-read (WAR) hazard, write-after-write (WAW) hazard, and read-after-write (RAW) hazard.

5. The method of claim 1, wherein at least one of the first and second instructions comprise operands expressed as a range of two or more registers.

6. The method of claim 5, wherein the range of two or more registers is represented by a start address and an end address.

7. The method of claim 5, wherein the first instruction comprises an operand expressed as a first range of registers and the second instruction comprises an operand expressed as a second range of registers, and the data hazard is determined by comparing the first range and the second range and detecting at least one common register between the first range and the second range.

8. The method of claim 7, wherein the comparing is performed at the granularity of data access of a register file accessed by the first and second instruction.

9. The method of claim 7, wherein at least one of the first range and the second range comprise non-contiguous registers.

10. The method of claim 1, wherein the first instruction is in an execution pipeline of the processor and the second instruction is in an out-of-order queue (OOQ).

11. A processor comprising:
a pipelined architecture configured to execute a first and a second instruction; and
a hit detection logic for comparing the first instruction to the second instruction to determine if there is a data hazard, prior to expanding the second instruction.

12. The processor of claim 11, wherein at least one of the first instruction and the second instruction comprises non-contiguous registers and the hit detection logic is further configured to evaluate the data hazard only for the specified non-contiguous registers present in the respective ranges.

13. The processor of claim 11, wherein at least one of the first instruction and the second instruction comprises one or more operands expressed as a range of registers.

14. The processor of claim 11, wherein the second instruction is older than the first instruction.

15. The processor of claim 14 further comprising:
one or more parallel execution pipelines with one or more pipeline stages, wherein the first instruction is in a first pipeline stage of a first execution pipeline; and
an out-of-order queue (OOQ) comprising one or more instructions, configured to dispatch instructions to the execution pipelines out-of-order, wherein the second instruction is in the OOQ.

16. The processor of claim 15, further comprising logic coupled to the OOQ to track the age of the second instruction, wherein the hit detection logic is configured to implement a masking function to evaluate the data hazard only if the second instruction is older than the first instruction.

17. The processor of claim 15, wherein the first instruction comprises operands expressed as a first range with a first start address and a first end address; and the second instruction comprises operands expressed as a second range with a second start address and a second end address, wherein the hit detection logic is configured to evaluate the data hazard by implementing the logical function: (the first start address≦second end address) and (the first end address≧the second start address).

18. The processor of claim 15, wherein the second instruction further comprises a valid bit, and the hit detection logic is configured to evaluate the data hazard only if the valid bit is set.

19. The processor of claim 11, integrated in at least one semiconductor die.

20. The processor of claim 11, integrated into a device selected from the group consisting of a set top box, music player, video player, entertainment unit, navigation device, communications device, personal digital assistant (PDA), fixed location data unit, and a computer.

21. A processing system for tracking data hazards in a processor comprising:
means for tracking a first instruction; and
means for comparing the first instruction to a second instruction to determine if there is a data hazard, prior to expanding the second instruction.

22. The processing system of claim 21, wherein the second instruction is an older instruction.

23. A non-transitory computer-readable storage medium comprising code, which, when executed by a processor, causes the processor to perform operations for tracking data hazards in the processor, the non-transitory computer-readable storage medium comprising:
code for tracking a first instruction; and
code for comparing the first instruction to a second instruction to determine if here is a data hazard, prior to expanding the second instruction.

24. The non-transitory computer-readable storage medium of claim 23, wherein the second instruction is an older instruction.
